(19) United States
(12) Patent Application Publication
(10) Pub. No.: US 2018/0163550 A1
(43) Pub. Date: Jun. 14, 2018

(54) TRANSITION DUCTS OF A GAS TURBINE COMBUSTOR

(71) Applicant: Siemens Aktiengesellschaft, München (DE)

(72) Inventors: Timothy A. FOX, Hamilton (CA); Jacob William HARDES, Charlotte, NC (US); Manish KUMAR, Charlotte, NC (US)

(21) Appl. No.: 15/574,911

(22) PCT Filed: Aug. 6, 2015
(86) PCT No.: PCT/US2015/043955

§ 371 Date: Nov. 17, 2017

(51) Int. Cl. F01D 9/02

(52) U.S. Cl. CPC F01D 9/023; F05D 2240/12

(57) ABSTRACT

A combustor has a trailing edge duct (110) that has a trailing edge (120) that is adapted to be connected to an adjacent trailing edge (120) of a trailing edge duct (110). The connections between the adjacent trailing edges may be formed along the lengthwise direction of the trailing edges and/or using interfacing components.

### BACKGROUND

### 1. Field

Disclosed embodiments are generally related to gas turbine combustors and, more particularly to the attachment means for the ducts.

### 2. Description of the Related Art

Previously annular gas turbine engines included several individual combustor cans that were disposed radially outside of and axially aligned with a rotor shaft. Combustion gases produced in the combustor cans were guided radially inward and then transitioned to axial movement by a transition duct. Turning vanes then received the combustion gases, accelerated the gases and directed the gases for delivery into a first stage of turbine blades.

In these gas turbine combustors an integrated exit piece (IEP) design had been used. In the IEP design, the transition ducts would merge to form a converging flow junction (CFJ). FIG. 1 shows a CFJ transition duct 10 that had been used to form the CFJ junction.

The CFJ transition duct 10 has a primary opening 11 located at the main casting duct portion 12 and a secondary opening 17 located at the top sheet duct portion 14. The CFJ transition duct 10 was constructed by being cast as a unitary piece. Additionally shown in FIG. 1 is the flange 16 and circular flange 19 which have bolt holes 13 formed therein. The bolt holes 13 are used to interconnect the IEPs of the combustors.

CFJ transition duct 10 was cooled via a pattern of ribs 18 supported on the outside surface of the main casting duct portion 12 and the top sheet duct portion 14. The manner in which the ribs 18 cooled the CFJ transition duct 10 created stress challenges in the connection between the main casting duct portion 12 and the top sheet duct portion 14. Furthermore, high stresses would occur at the central notch 15.

The stress challenges created by the geometry of the CFJ duct 10 and the manner in which the CFJ transition ducts 10 were connected resulted in limitations with respect to the structural integrity of the ducts themselves and the connection of the main casting duct portions 12 around the gas turbine engines.

To overcome this problem the trailing edge duct was developed. A feature of the trailing edge ducts is the connectivity of adjacent trailing edge ducts and improved means for connecting adjacent trailing edge ducts.

### SUMMARY

Briefly described, aspects of the present disclosure relate to trailing edge ducts used with gas turbine combustors.

An aspect of the disclosure is a trailing edge duct having a main duct portion. The trailing edge duct also has an extension flange connected to the main duct portion, wherein the main duct portion and the extension flange form a trailing edge, wherein the trailing edge is adapted to connect to an adjacent trailing edge along the entire length of the trailing edge.

Another aspect of the disclosure is a system having a first trailing edge duct, wherein the first trailing edge duct comprises a first main duct portion and a first extension flange connected to the first main duct portion, wherein the first main duct portion and the first extension flange form a first trailing edge; a second trailing edge duct, wherein the second trailing edge duct comprises a second main duct portion and a second extension flange connected to the second main duct portion, wherein the second main duct portion and the second extension flange form a second trailing edge. Also in the system the first trailing edge and the second trailing edge form a connection, wherein the connection extends along a lengthwise direction.

Still yet another aspect of the disclosure is a trailing edge duct having a main duct portion, an extension flange connected to the main duct portion, wherein the main duct portion and the extension flange form a trailing edge; wherein the trailing edge is adapted to connect to an adjacent trailing edge with a boltless interfacing component.

### BRIEF DESCRIPTION OF THE DRAWINGS

FIG. 1 shows a prior art view of a converging flow junction transition duct.

FIG. 2 shows a trailing edge duct.

FIG. 3 shows the connection of adjacent trailing edge ducts.

FIG. 4 shows the connection of adjacent trailing edge ducts using a bolt.

FIG. 5 shows a top down view of an alternative embodiment of a connection of the adjacent trailing edge ducts.

FIG. 6 shows a top down view of an alternative embodiment of a connection of the adjacent trailing edge ducts.

FIG. 7 shows a top down view of an alternative embodiment of a connection of the adjacent trailing edge ducts.

FIG. 8 shows a top down view of an alternative embodiment of a connection of the adjacent trailing edge ducts.

FIG. 9 shows a top down view of an alternative embodiment of a connection of the adjacent trailing edge ducts.

FIG. 10 shows a top down view of an alternative embodiment of a connection of the adjacent trailing edge ducts.

FIG. 11 shows a top down view of an alternative embodiment of a connection of the adjacent trailing edge ducts.

FIG. 12 shows a top down view of an alternative embodiment of a connection of the adjacent trailing edge ducts.

### DETAILED DESCRIPTION

To facilitate an understanding of embodiments, principles, and features of the present disclosure, they are explained hereinafter with reference to implementation in illustrative embodiments. Embodiments of the present disclosure, however, are not limited to use in the described systems or methods.

The components and materials described hereinafter as making up the various embodiments are intended to be illustrative and not restrictive. Many suitable components and materials that would perform the same or a similar function as the materials described herein are intended to be embraced within the scope of embodiments of the present disclosure.

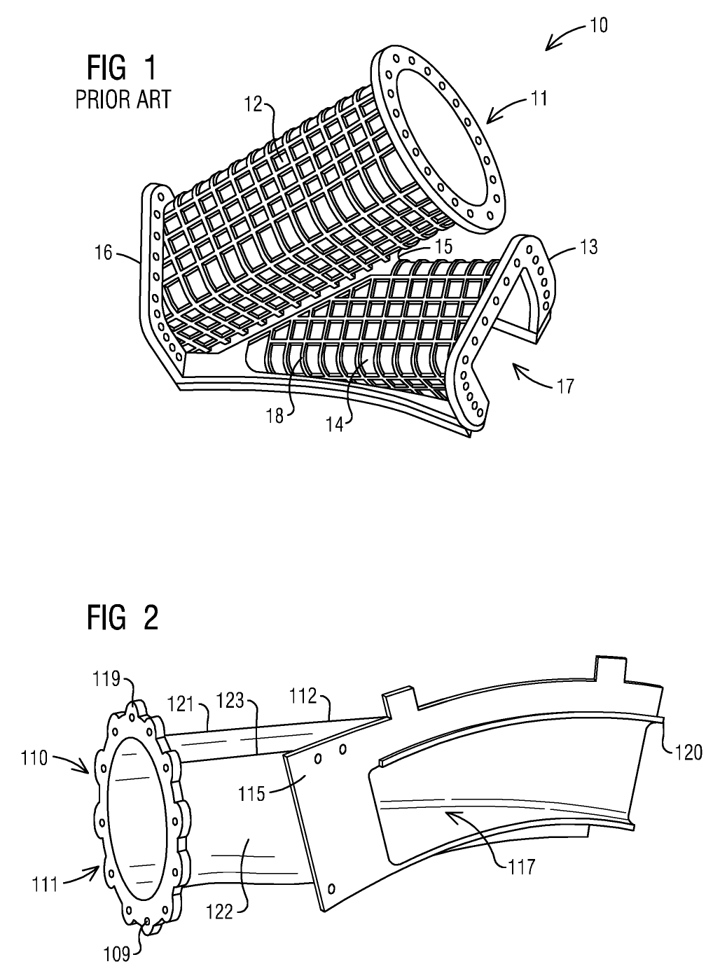

FIG. 2 shows a trailing edge duct 110 with which aspects of the present invention can be employed. The trailing edge duct 110 has a main duct portion 112 having a primary opening 111 and secondary opening 117. The main duct portion 112 may be formed of more than one panel, for example the main duct portion 112 shown in FIG. 2 is formed from a first main panel portion 121 and a second main panel portion 122 that are joined at a seam 123 via welding. The primary opening 111 receives fluids during operation in gas turbine engines. Located at and surrounding the primary opening 111 is an annular flange 119 having through holes 109 located therein. Located at the secondary opening 117 is an extension flange 115, which is discussed in more detail below. The extension flange 115 and the main duct portion 112 together form the trailing edge 120 of the trailing edge duct 110.

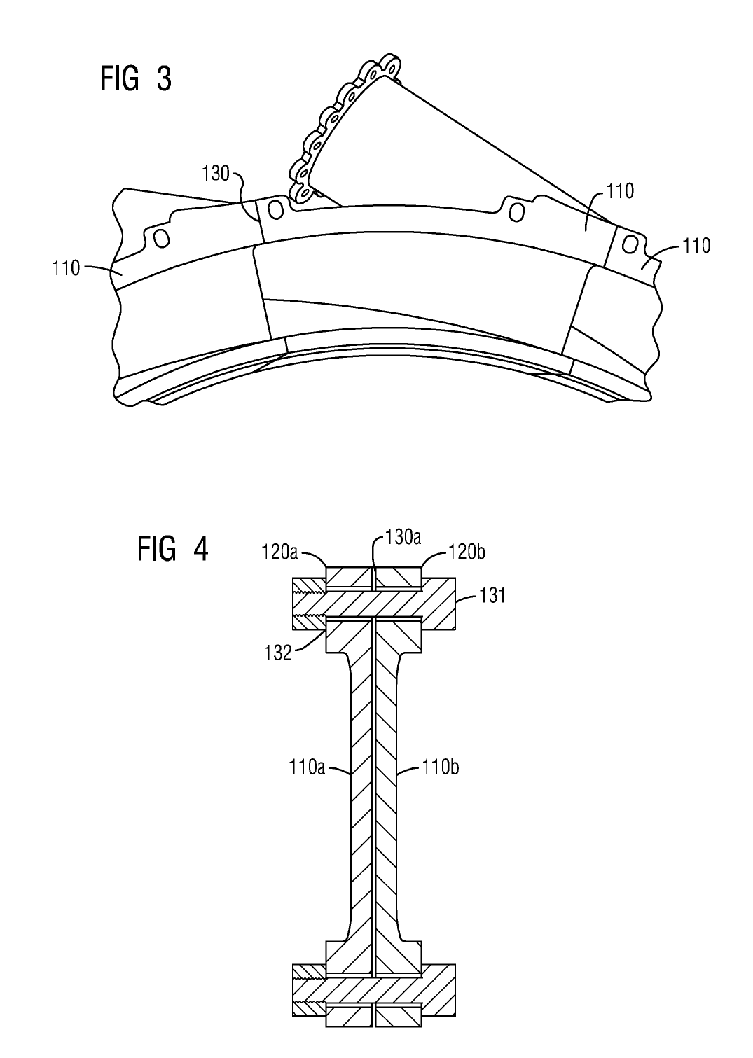

The trailing edges 120 of the trailing edge ducts 110 are connected together to form a ring so that one trailing edge duct 110 is connected to another. FIG. 3 shows adjacent trailing edge ducts 110a, 110b and 110c connected together at connections 130. By “connection” it is meant the interface between adjacent trailing edge ducts 110 along one of the interfaces.

Now turning to FIG. 4 shown is a connection between the trailing edge duct 110a and trailing edge duct 110b. In the embodiment shown in FIG. 4, bolt 131 is placed into through hole 132 located in the trailing edge ducts 110a and 110b, proximate to the trailing edges 120a, 120b in order to form the connection 130a. While such a connection is effective, additional connection means may be employed to further create a secure interface.

In the embodiments described below interfacing components are used in order to connect trailing edge ducts in a secure fashion. The interfacing components are described in more detail below with specific descriptions related to the interfacing components.

Turning to FIG. 5, shown is a top down view of a connection 130b between two trailing edge ducts 110c, 110d at trailing edges 120c and 120d. The trailing edges 120c and 120d have formed thereon trapezoidal interlocking pieces 133a and 133b. The trapezoidal interlocking pieces 133a and 133b mesh together in order to secure the trailing edges 120c and 120d. The connection 130b formed is one that extends the entire length of the trailing edges 120c and 120d. The length “L” of trailing edges 120c and 120d extends from the distal tip to the opposite end of the trailing edges 120c and 120d. Similarly, throughout the application the length “L” of the trailing edge is taken to be this dimension. This formation securely connects the two trailing edge ducts 110c, 110d. The connection 130b can also work in conjunction with bolts 131 and through holes 132.

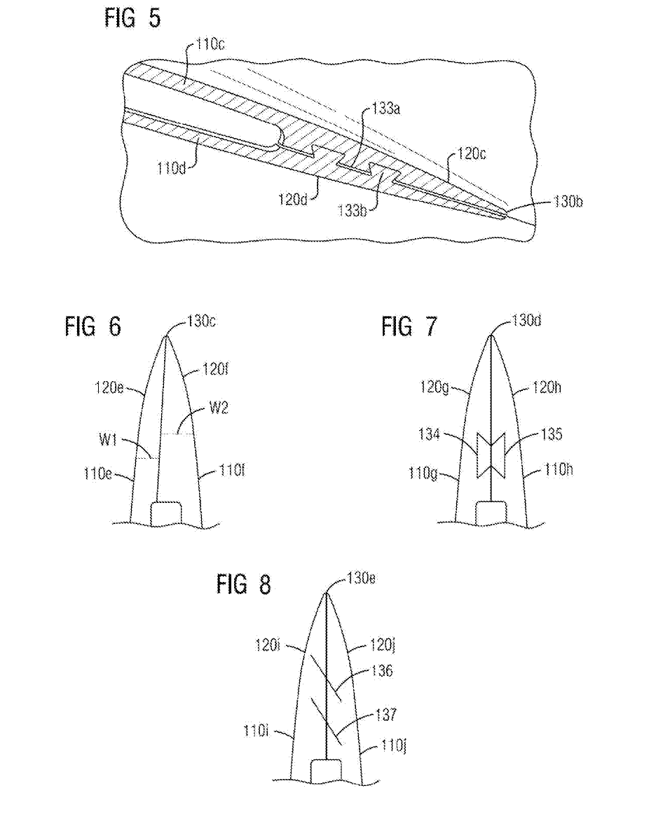

Referring to FIG. 6, the two trailing edge ducts 110e and 110f form the connection 130c using the trailing edges 120e and 120f. In this embodiment the trailing edge 120e has a width W₁ that is less than the width W₂ of trailing edge 120f, which is to say the width at any given location of trailing edge 120e is less than the width of the trailing edge 120f at the same location. In some embodiments the widths W₁ and W₂ may vary over the height of the trailing edges 120e and 120f, for example the widths may be similar at the base of the trailing edges 120e and 120f and vary from each other as they along the height of the trailing edges 120e and 120f. So for example, trailing edge 120f may have a width W2 which increases with respect to W1 over a range of 0 to 50% along the height of the trailing edge 120f. In this embodiment pressure from the incoming fluids facilitates the connection 130c of the trailing edges 120e and 120f The connection 130c formed is one that extends the entire length of the trailing edges 120e and 120f The connection 130c can also work in conjunction with bolts 131 and through holes 132.

Referring to FIG. 7, the two trailing edge ducts 110g and 110h form the connection 130d using the trailing edges 120g and 120h. In this embodiment the trailing edges 120g and 120h have formed therein trapezoidal slots 134 adapted to receive a bowtie connector 135 that fits into both the trapezoidal slots 134. More than one pair of trapezoidal slots 134 and bowtie connectors 135 may be used. The bowtie connector 135 secures the trailing edges 120g and 120h together and forms the connection 130d. The connection 130d formed is one that extends the entire length of the trailing edges 120g and 120h. The connection 130d can also work in conjunction with bolts 131 and through holes 132.

Referring to FIG. 8, the two trailing edge ducts 110i and 110j form the connection 130e using the trailing edges 120i and 120j. In this embodiment the trailing edges 120i and 120j have formed therein slots 136. In the embodiment shown four diagonal slots 136 are shown, two for each of the trailing edges 120i and 120j. However it should understood that more or less diagonal slots 136 may be used. The diagonal slots 136 are adapted to receive diagonal connectors 137. One diagonal connection 136 joins two diagonal slots 136. While called diagonal connectors 137, it should be understood that the diagonal connectors 137 are diagonal with respect to the lengthwise axis A of the connection 130d and the trailing edges 120i and 120j. The connection 130e formed is one that extends the entire length of the trailing edges 120i and 120j. The connection 130e can also work in conjunction with bolts 131 and through holes 132.

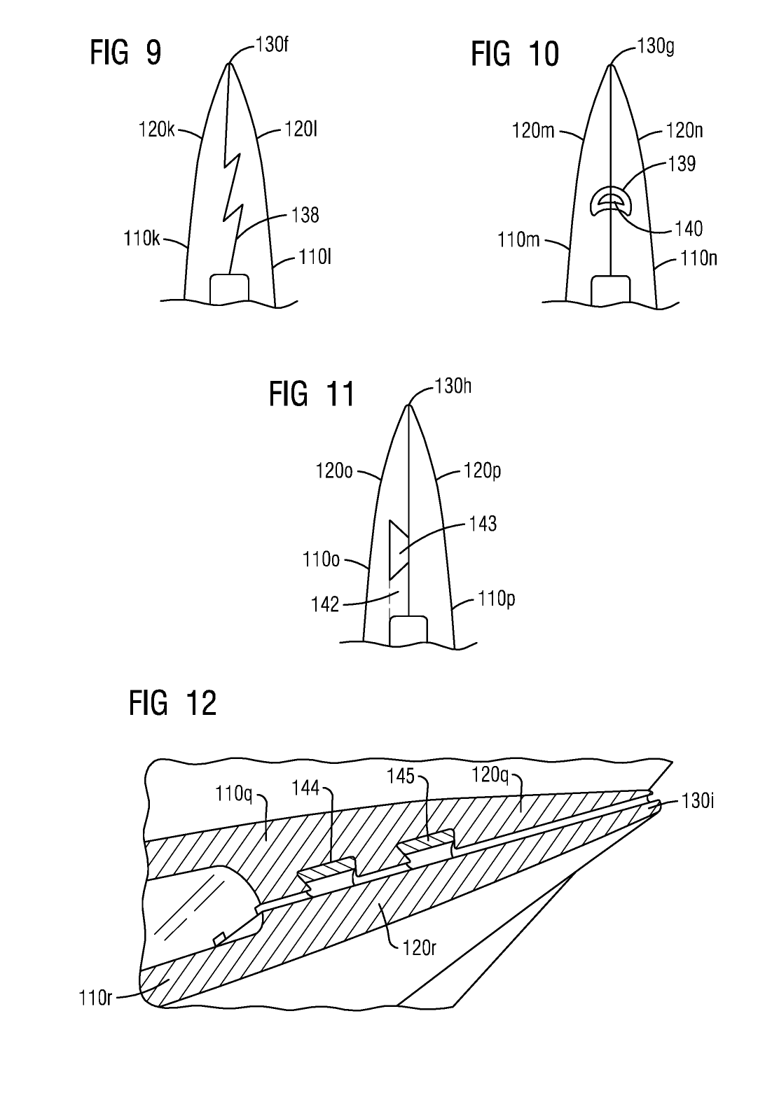

Referring to FIG. 9, the two trailing edge ducts 110k and 110l form the connection 130f using the trailing edges 120k and 120l. In this embodiment the trailing edges 120k and 120l have formed therein lightening-shaped or jagged slots 138 which form a jagged connection 130f The jagged slots 138 in each of the trailing edges 120k and 120l have corresponding jagged slots 138 in the opposite trailing edges 120k and 120l. The jagged slots 138 help secure the trailing edges 120k and 120l. The connection 130f formed is one that extends the entire length of the trailing edges 120k and 120l. The connection 130f can also work in conjunction with bolts 131 and through holes 132.

Referring to FIG. 10, the two trailing edge ducts 110m and 110n form the connection 130g using the trailing edges 120m and 120n. In this embodiment the trailing edges 120m and 120n have formed therein arched slots 139 which when forming connection 130g is shaped like a parabola. The arched slots 139 receive an arched connector 140. The arch slots 139 and arched connector 140 help secure the trailing edges 120m and 120n. The connection 130g formed is one that extends the entire length of the trailing edges 120m and 120n. The connection 130g can also work in conjunction with bolts 131 and through holes 132.

Referring to FIG. 11, the two trailing edge ducts 110o and 110p form the connection 130h using the trailing edges 120o and 120p. In this embodiment trailing edge 120o has a rectangular slot 142 formed therein that is adapted to receive a wedge connector 143. The rectangular slot 142 and wedge connector 143 help secure the trailing edges 120o and 120p. The connection 130h formed is one that extends the entire length of the trailing edges 120o and 120p. The connection 130h can also work in conjunction with bolts 131 and through holes 132.

Turning to FIG. 12, shown is a top down view of a connection 130i between two trailing edge ducts 110q, 110r at trailing edges 120q and 120r. The trailing edges 120q has trapezoidal stepped slots 144 that mesh with trapezoidal steps 145 to form connection 130i. The stepped formation provides additional interlocking ability for the trailing edge ducts 110q, 110r. Other formation shapes may be used that employ a step configuration, such as rectangular, arced shape, triangular, pentagonal, hexagonal etc. The connection 130i formed is one that extends the entire length of the trailing edges 120q and 120r. This formation securely connects the two trailing edge ducts 110q, 110r. The connection 130i can also work in conjunction with bolts 131 and through holes 132.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed is:

1. A trailing edge duct (110) comprising:
a main duct portion (112);
an extension flange (115) connected to the main duct portion (112), wherein the main duct portion (112) and the extension flange (115) form a trailing edge (120), wherein the trailing edge (120) is adapted to connect to an adjacent trailing edge along the entire length of the trailing edge.

2. The trailing edge duct of claim 1, wherein the trailing edge (120c, 120d) has a plurality of trapezoidal interlocking pieces (133a, 133b).

3. The trailing edge duct of claim 1, wherein the trailing edge (120g, 120d) has a trapezoidal slot (134) adapted to receive a bowtie connector (135).

4. The trailing edge duct of claim 1, wherein the trailing edge (120i, 120j) has formed therein diagonal slots (136) in reference to the length of the trailing edge.

5. The trailing edge duct of claim 1, wherein the trailing edge (120k, 120l) has formed therein a jagged slot (138).

6. The trailing edge duct of claim 1, wherein the trailing edge (120q) has a stepped formation.

7. The trailing edge duct of claim 1, wherein the trailing edge (120m, 120n) has an arched slot (139).

8. A system comprising:
a first trailing edge duct (110), wherein the first trailing edge duct (110e) comprises a first main duct portion (112) and a first extension flange (115) connected to the first main duct portion (112), wherein the first main duct portion (112) and the first extension flange (115) form a first trailing edge (120);
a second trailing edge duct (110), wherein the second trailing edge duct (110) comprises a second main duct portion (112) and a second extension flange (115) connected to the second main duct portion (112), wherein the second main duct portion (112) and the second extension flange (115) form a second trailing edge (120); and
wherein the first trailing edge and the second trailing edge form a connection, wherein the connection extends along a lengthwise direction.

9. The system of claim 8, wherein the first trailing edge (120o) has a rectangular slot (142) and the second trailing edge (120p) has a wedge connector (143).

10. The system of claim 8, wherein the first trailing edge (120e) is wider than the second trailing edge (120f).

11. The system of claim 8, further comprising a bowtie connector (135) adapted to secure the first trailing edge (120g) and the second trailing edge (120h).

12. The system of claim 8, further comprising a plurality of diagonal connectors (137) adapted to secure the first trailing edge (120i) and the second trailing edge (120j).

13. The system of claim 8, further comprising an arched connector (130) adapted to secure the first trailing edge (120m) and the second trailing edge (120n).

14. The system of claim 8, wherein the first trailing edge (120c) and the second trailing edge (120d) has a plurality of trapezoidal interlocking pieces (133c, 133b).

15. The system of claim 8, wherein the first trailing edge (120c) and the second trailing edge (120d) form a jagged connection.

16. The system of claim 8, wherein the first trailing edge (120q) has a stepped formation.

17. A trailing edge duct comprising:
a main duct portion (112);
an extension flange (115) connected to the main duct portion (112), wherein the main duct portion (112) and the extension flange (115) form a trailing edge (120), wherein the trailing edge (120) is adapted to connect to an adjacent trailing edge with a boltless interfacing component.

18. The trailing edge duct of claim 17, wherein the interface component is a trapezoidal interlocking piece (133a, 133b).

19. The trailing edge duct of claim 17, wherein the interface component is a trapezoidal slot (134) adapted to receive a bowtie connector (135).

20. The trailing edge duct of claim 17, wherein the interface component is a jagged slot (138).
